(19) United States
(12) Patent Application Publication
(10) Pub. No.: US 2026/0310048 A1
(43) Pub. Date: Oct. 8, 2026

(54) LENS DRIVING DEVICE AND CAMERA ASSEMBLY

(71) Applicant: XIAMEN ZHONGHUI MICROELECTRONICS CO.,LTD., Xiamen (CN)

(72) Inventors: Yuqin Yi, Putian (CN); Xiaotao Jin, Chibi (CN); Chi-Lung Chang, Hsinchu (CN)

(21) Appl. No.: 19/417,353

(22) Filed: Dec. 12, 2025

(30) Foreign Application Priority Data
Apr. 2, 2025 (CN) 202510408840.X

(51) Int. Cl. G03B 13/36

(52) U.S. Cl. CPC G03B 13/36

(57) ABSTRACT

A lens driving device includes a base, an AF movable part movably disposed on the base, and a lens mount movably disposed on the AF movable part. The AF movable part includes an AF frame and multiple horizontal suspension wires. The AF frame is movably disposed on the base. An end of each horizontal suspension wire is connected to the AF frame, and another end of each horizontal suspension wire is connected to the base. The lens mount is movably disposed on the AF frame. The lens driving device is free of a spring plate. This device employs the horizontal suspension wires as an AF suspension architecture to achieve a friction-free design, uses a first rolling element and two second rolling elements as an OIS guiding architecture, and uses the horizontal suspension wires as power and signal traces to achieve electrical connection with the base, simplifying an overall structure.

### CROSS-REFERENCE TO RELATED APPLICATION

This application claims priority to Chinese Patent Application No. 202510408840.X, filed on Apr. 2, 2025, which is herein incorporated by reference in its entirety.

### TECHNICAL FIELD

The disclosure relates to the field of optical image stabilization (OIS) technologies, and more particularly to a lens driving device and a camera assembly.

### BACKGROUND

Currently, the demand for camera performance in portable electronic devices (such as tablet computers, smartphones, etc.) continues to grow rapidly. To meet diverse requirements for imaging performance, an anti-shake motor is typically integrated into a camera assembly, performing motion compensation on the camera assembly during an image capture process, thereby improving image quality.

At present, most conventional anti-shake motors on the market employ an architecture with upper and lower spring plates and suspension wires, or a dual-layer ball scheme to achieve anti-shake functionality. However, the conventional architecture with spring plates and suspension wires requires the addition of numerous components to realize a three-axis closed-loop design, resulting in a complex overall structure and high manufacturing costs. The dual-layer ball scheme, due to its dual-layer ball structure, demands considerable space for its OIS guiding mechanism, making miniaturization impossible. Furthermore, the ball structure exhibits friction and requires additional lubricant, making assembly very difficult.

It should be noted that information disclosed in this “BACKGROUND” section is intended solely to enhance the understanding of the overall background of the disclosure, and should not be regarded as an admission or any form of suggestion that such information constitutes related art already well known to those skilled in the art.

### SUMMARY

To solve deficiencies of existing anti-shake motors mentioned above, the disclosure provides a lens driving device, which includes a base, an auto focus (AF) movable part, and a lens mount. The AF movable part is movably disposed on the base, and the lens mount is movably disposed on the AF movable part.

The AF movable part includes an AF frame and multiple horizontal suspension wires. The AF frame is movably disposed on the base. An end of each of the multiple horizontal suspension wires is connected to the AF frame, and another end of each of the multiple horizontal suspension wires is connected to the base. The lens mount is movably disposed on the AF frame.

The lens driving device is free of a spring plate.

In an embodiment, a magnetic conductive plate is disposed on an outer side wall of the base.

In an embodiment, a first substrate is disposed on an outer side wall of the base, and the multiple horizontal suspension wires are connected to the first substrate. A first coil is disposed on a side of the first substrate facing towards the AF frame, and a first magnet is disposed on the AF frame at a position corresponding to the first coil.

In an embodiment, the lens driving device further includes embedded components and two second coils. The embedded components are disposed in the AF frame, and the embedded components are electrically connected to the multiple horizontal suspension wires. The two second coils are disposed on a side of the AF frame facing towards the lens mount, and the two second coils are electrically connected to the embedded components respectively. Two second magnets are disposed on the lens mount at positions corresponding to the two second coils respectively.

In an embodiment, the two second coils are respectively disposed at two adjacent corners of the AF frame and are disposed on a side of the AF frame facing away from a first substrate.

In an embodiment, the two second coil are arranged obliquely.

In an embodiment, the AF frame defines a first rolling groove and two second rolling grooves. The first rolling grooves is disposed between the two second coils, and the two second rolling grooves are positioned opposite to the two second coils respectively.

A first rolling element is movably disposed in the first rolling groove, and second rolling elements are movably disposed in the two second rolling grooves respectively. The first rolling element and the second rolling elements are movably connected to the lens mount.

In an embodiment, each of the second rolling elements is a roller.

In an embodiment, the lens driving device further includes a damping cover plate, and the damping cover plate is connected to the AF frame.

The lens mount defines multiple damping grooves, and the damping cover plate is provided with multiple damping portions. The multiple damping portions respectively extend into the multiple damping grooves, and the multiple damping portions are movably connected to the multiple damping grooves respectively.

In an embodiment, the disclosure further provides a camera assembly, which employs the lens driving device as described above.

Based on the above, the lens driving device and the camera assembly provided by the disclosure, compared with the related art, employ the horizontal suspension wires as an AF suspension architecture to achieve a friction-free design, use the first rolling element and the two second rolling elements as an OIS guiding architecture, and use the horizontal suspension wires as power and signal traces to achieve electrical connection with the base. On the basis of three-axis closed-loop control, The disclosure simplifies an overall structure, optimizes manufacturing processes and production costs, simultaneously reduces magnetic leakage, and prevents magnetic interference with external components.

### BRIEF DESCRIPTION OF DRAWINGS

To more clearly illustrate technical solutions in embodiments of the disclosure or in the related art, attached drawings that need to be used in the description of the embodiments or the related will be briefly introduced below. Apparently, the attached drawings described below are merely some embodiments of the disclosure. For those skilled in the art, other attached drawings can be obtained based on these attached drawings without creative effort. Unless otherwise specified, positional relationships referred to in the following description are all based on the orientation of components as shown in the attached drawings.

FIG. 1 illustrates an exploded view of a lens driving device according to an embodiment of the disclosure.

FIG. 2 illustrates an exploded view of a base according to the embodiment of the disclosure.

FIG. 3 illustrates a schematic structural diagram of the base and an AF frame according to the embodiment of the disclosure.

FIG. 4 illustrates an exploded view of the AF frame and a lens mount according to the embodiment of the disclosure.

FIG. 5 illustrates a schematic diagram of a connection structure between horizontal suspension wires and embedded components according to the embodiment of the disclosure.

### DESCRIPTION OF REFERENCE SIGNS

10—base; 20—AF movable part; 30—lens mount; 40—first coil; 50—magnetic conductive plate; 60—embedded component; 70—second coil; 80—second driver integrated circuit (IC); 90—third driver IC; 100—first rolling element; 110—second rolling element; 120—shielding cover; 130—damping cover plate; 11—first substrate; 12—first driver IC; 21—AF frame; 22—horizontal suspension wire; 23—first magnet; 24—first rolling groove; 25—second rolling groove; 31—second magnet; 32—third rolling groove; 33—fourth rolling groove; 34—damping groove; 131—damping portion.

### DETAILED DESCRIPTION OF EMBODIMENTS

To make purposes, technical solutions, and advantages of embodiments of the disclosure clearer, the technical solutions in the embodiments of the disclosure will be described clearly and completely below in conjunction with attached drawings in the embodiments of the disclosure. Obviously, described embodiments are only a part of the embodiments of the disclosure, not all of them. Based on the embodiments of the disclosure, all other embodiments obtained by those skilled in the art without creative efforts shall fall within the scope of protection of the disclosure.

In the description of the disclosure, it should be noted that terms “center”, “longitudinal”, “transverse”, “upper”, “lower”, “front”, “rear”, “left”, “right”, “vertical”, “horizontal”, “top”, “bottom”, “inner”, “outer” and the like indicate orientations or positional relationships based on those shown in the attached drawings, and are used solely for convenience in describing the disclosure and simplifying the description. These terms are not intended to indicate or imply that referenced device or element must have a particular orientation, or be constructed or operated in a particular orientation, and therefore should not be construed as limiting the disclosure. In addition, terms such as “first” and “second” are used merely for descriptive purposes, and should not be construed as indicating or implying relative importance, or as implicitly specifying a number of technical features. Thus, a feature defined as “first” or “second” may explicitly or implicitly include one or more such features. In the description of the disclosure, unless otherwise stated, the term “multiple” means two or more. Furthermore, the term “include” (and any variation thereof) is to be understood as “at least include”.

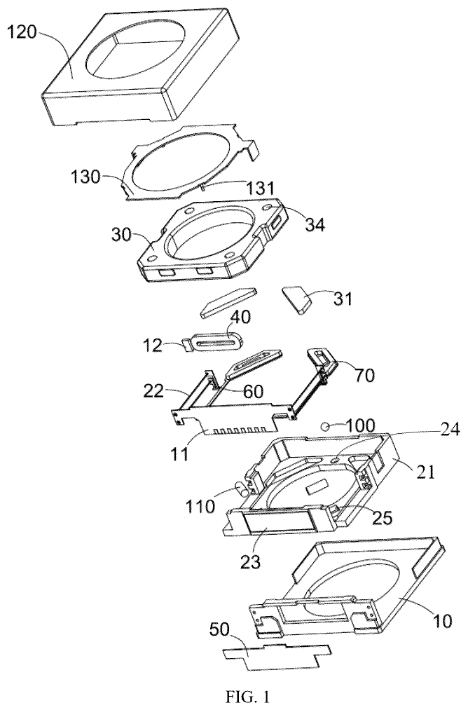

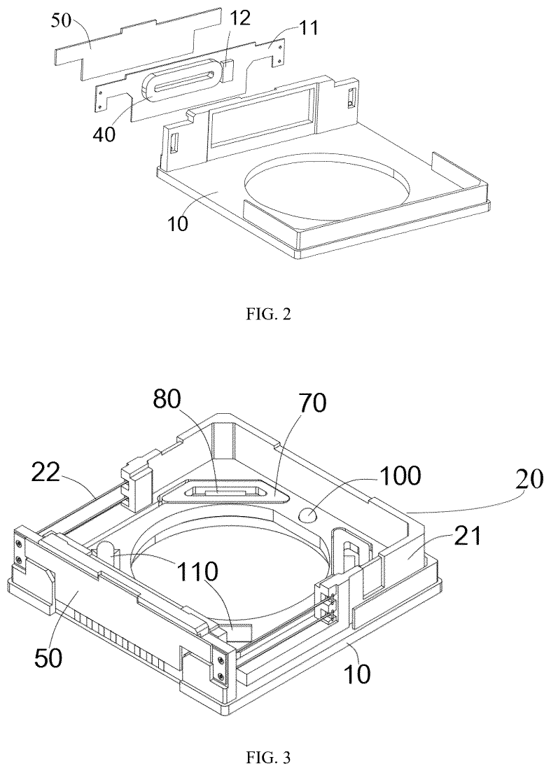

As shown in FIGS. 1 and 2, FIG. 1 illustrates an exploded view of a lens driving device according to an embodiment of the disclosure; and FIG. 2 illustrates an exploded view of a base according to the embodiment of the disclosure.

To solve deficiencies of conventional anti-shake motors in the related art, or to achieve at least one of associated advantages or other advantages, the embodiment of the disclosure provides a lens driving device. As shown in the attached drawings, the lens driving device includes a base 10, an AF movable part 20, and a lens mount 30.

A first substrate 11 is disposed on an outer side wall of the base 10. The first substrate 11 is provided with power and signal traces, achieving power and signal routing for an entire motor.

As shown in FIG. 3, the AF movable part 20 is movable disposed on the base 10. Specifically, the AF movable part 20 includes an AF frame 21 and multiple horizontal suspension wires 22. The AF frame 21 is movably disposed on the base 10. An end of each horizontal suspension wire 22 is connected to the AF frame 21, and another end of each horizontal suspension wire 22 is connected to the base 10.

Specifically, a number of the horizontal suspension wires 22 is four. The four horizontal suspension wires 22 are arranged in two vertically-spaced, parallel pairs on opposite sides of the AF frame 21. An end of each of the four horizontal suspension wires 22 is connected to the AF frame 21, and another end of each of the four suspension wires 22 is connected perpendicularly to the first substrate 11, thereby forming a suspension architecture for the AF frame 21. This configuration enables the AF frame 21 to move smoothly and stably along a Z-axis relative to the base 10 to achieve focusing.

Furthermore, a first coil 40 is disposed on a side of the first substrate 11 facing towards the AF frame 21, and a first magnet 23 is disposed on the AF frame 21 at a position corresponding to the first coil 40. When the first coil 40 is energized, it generates an Ampere force under the magnetic field of the first magnet 23 to perform cutting magnetic induction line motion, driving the AF frame 21 move along the Z-axis for motion compensation, thereby achieving focus adjustment and anti-shake purposes.

Specifically, a first driver IC 12 is disposed on the first substrate 11 for sensing and controlling the movement of the AF frame 21 in the Z-axis.

Due to the use of the suspension architecture with the four horizontal suspension wires 22 in the AF movable part 20, t a frictionless design is achieved. However, when the AF frame 21 moves along the Z-axis, an imbalance in force distribution among upper and lower suspension wires 22 may cause tilting of the AF frame 21. To address this problem, a magnetic conductive plate 50 is disposed on a side of the first substrate 11 facing away from the AF frame 21. An attractive magnetic force generated between the magnetic conductive plate 50 and the first magnet 23 ensures the stability of the AF frame 21, preventing tilting or toppling issues and thereby improving image quality.

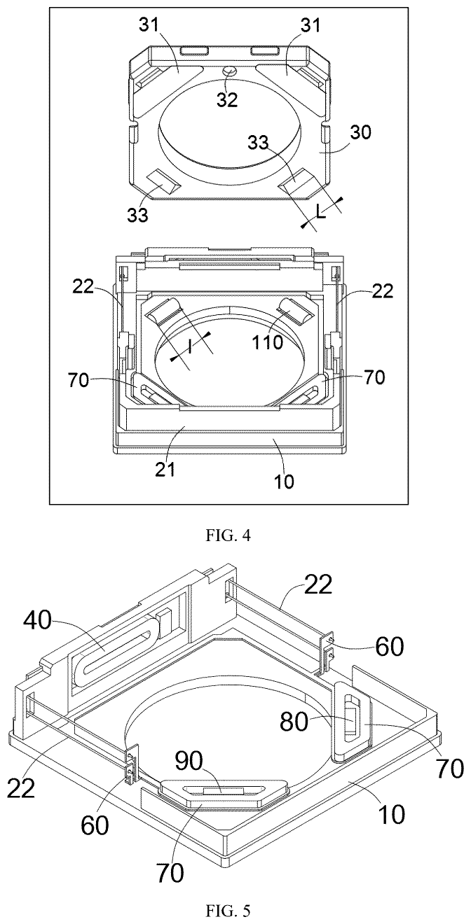

Referring to FIGS. 4 and 5 in conjunction with FIG. 1, the lens mount 30 movably disposed on the AF frame 21. Specifically, the lens driving device further includes embedded components 60 and two second coils 70. The embedded components 60 are pre-embedded inside the AF frame 21 and are electrically connected to the four horizontal suspension wires 22. The two second coils 70 are disposed on a side of the AF frame 21 facing towards the lens mount 30 in a mutually perpendicular direction, and the two second coils 70 are electrically connected to the embedded components 60 respectively. Utilizing the four horizontal suspension wires 22 for power and signal routing eliminates conventional components such as spring plates plus suspension wires. This not only avoids errors caused by deformation of the spring plates but also simplifies architectural complexity and manufacturing difficulty, facilitating assembly and reducing production costs.

Two second magnets 31 are disposed on the lens mount 30 at positions corresponding to the two second coils 70 respectively. When the two second coils 70 are energized, they generate Ampere forces under the magnetic fields of the second magnets 31 to perform cutting magnetic induction line motion respectively, driving the lens mount 30 to move along an X-axis and/or a Y-axis for motion compensation, thereby achieving image stabilization and improving image quality.

Specifically, a second driver IC 80 and a third driver IC 90 are respectively disposed inside the two coils 70, and the second driver IC 80 and the third driver IC 90 are configured to monitor and control movement of the lens mount 30 along the X-axis and Y-axis respectively.

In some specific embodiments, the two second coils 70 are respectively disposed at two adjacent corners of the AF frame 21 and are disposed on a side of the AF frame 21 facing away from the first substrate 11. That is, arrangement positions of the two second coils 70 and an arrangement position of the first magnet 23 are disposed on opposite sides of the AF frame 21. By concentrating arrangement positions of the two second coils 70, the two second magnets 31, the first coil 40, and the first magnet 23 on a same side of the base 10, magnetic leakage of the overall anti-shake motor is reduced, enabling the arrangement of more lenses and anti-shake motors.

Furthermore, the two second coils 70 are arranged obliquely. Specifically, an oblique angle is 45°.

On the basis of the above, the AF frame defines a first rolling groove 24 and two second rolling grooves 25. The first rolling groove 24 is disposed between the two second rolling grooves 25. A first rolling element 100 is movably disposed in the first rolling groove 24. The lens mount 30 defines a third rolling groove 32 at a position corresponding to the first rolling groove 24. The first rolling element 100 is movably connected to the third rolling groove 32.

The two second rolling grooves 25 are positioned opposite to the second coils 70 respectively and are responsible for the movement along the X-axis and the Y-axis respectively. Second rolling elements 110 are movably disposed in the two second rolling grooves 25 respectively. The lens mount 30 defines fourth rolling grooves 33 at positions corresponding to the two second rolling grooves 25 respectively. The second rolling elements 110 are movably connected the fourth rolling grooves 33 respectively.

When the lens mount 30 moves relative to the AF frame 21 along the X-axis and/or the Y-axis for motion compensation, the first rolling element 100 and the second rolling elements 110 roll respectively establish rolling connections with the lens mount 30, enabling the lens mount 30 to smoothly and stably move along the X-axis and/or Y-axis for motion compensation, thereby improving image quality.

Specifically, the second rolling grooves 25 are inverted-trapezoid grooves, and the fourth grooves 33 are V-shaped grooves.

Furthermore, each second rolling element 110 is a roller. Compared with bearing balls or other types of rolling elements, the roller provides a larger support surface area, which reduces pressure concentration and avoids the formation of indentations that causes jitter or vibration of the lens mount 30. It is understood that due to the use of rollers, in order to allow normal motion compensation of the lens mount 30, a length L of each of the second rolling grooves 25 and the fourth rolling grooves 33 is slightly greater than a length l of the roller. This prevents mutual interference between each second rolling element 110 and a corresponding one of the second rolling grooves 25 and a corresponding one of the fourth rolling grooves 33.

In some specific embodiments, the lens driving device further includes a shielding cover 120 and a damping cover plate 130. Specifically, the shielding cover 120 and the base 10 are mutually covered. The damping cover plate 130 is disposed between the lens mount 30 and the shielding cover 120. The damping cover plate 130 is connected to the AF frame 21.

The lens mount 30 defines multiple damping grooves 34, and the damping cover plate 130 is provided with multiple damping portions 131. The multiple damping portions 131 respectively extend into the multiple damping grooves 34, and the multiple damping portions 131 are movably connected the multiple damping grooves 34 respectively. When the lens mount 30 moves along the X-axis and/or the Y-axis for motion compensation, a damping force is generated.

In some specific embodiments, the disclosure provides a camera assembly, which employs the lens driving device as described above.

In summary, the lens driving device and the camera assembly provided by the disclosure, compared with the related art, employ the horizontal suspension wires as the AF suspension architecture to achieve a friction-free design, use the first rolling element and the two second rolling elements as an OIS guiding architecture, and use the horizontal suspension wires as power and signal traces to achieve electrical connection with the base. On the basis of three-axis closed-loop control, the disclosure simplifies an overall structure, optimizes manufacturing processes and production costs, simultaneously reduces magnetic leakage, and prevents magnetic interference with external components.

Although terms such as “horizontal suspension wires” are used frequently herein, the use of other terms is not excluded. Such terms are employed merely to facilitate the description and interpretation of the essence of the disclosure, and interpreting them as any additional limitations is contrary to the spirit of the disclosure.

In addition, those skilled in the art should understand that, although many problems exist in the related art, each embodiment or technical solution of the disclosure may be improved in only one or several aspects, and does not necessarily have to solve all technical problems listed in the related art or background. Those skilled in the art should also understand that any content not mentioned in a claim should not be regarded as a limitation to that claim.

Finally, it should be noted that the above embodiments are only intended to illustrate the technical solutions of the disclosure and are not intended to limit them. Although the disclosure has been described in detail with reference to the above embodiments, those skilled in the art should understand that they can still modify the technical solutions described in the above embodiments, or make equivalent substitutions to some or all of the technical features therein. Such modifications or substitutions do not cause the essence of corresponding technical solutions to depart from the scope of the technical solutions of the embodiments of the disclosure.

What is claimed is:

1. A lens driving device, comprising:
a base;
an auto focus (AF) movable part, movably disposed on the base; and
a lens mount, movably disposed on the AF movable part;
wherein the AF movable part comprises an AF frame and a plurality of horizontal suspension wires, the AF frame is movably disposed on the base, an end of each of the plurality of horizontal suspension wires is connected to the AF frame, another end of each of the plurality of horizontal suspension wires is connected to the base, and the lens mount is movably disposed on the AF frame; and
wherein the lens driving device is free of a spring plate.

2. The lens driving device as claimed in claim 1, wherein a magnetic conductive plate is disposed on an outer side wall of the base.

3. The lens driving device as claimed in claim 1, wherein a first substrate is disposed on an outer side wall of the base, the plurality of horizontal suspension wires are connected to the first substrate, a first coil is disposed on a side of the first substrate facing towards the AF frame, and a first magnet is disposed on the AF frame at a position corresponding to the first coil.

4. The lens driving device as claimed in claim 1, wherein the lens driving device further comprises embedded components and two second coils; the embedded components are disposed in the AF frame, and the embedded components are electrically connected to the plurality of horizontal suspension wires; the two second coils are disposed on a side of the AF frame facing towards the lens mount, and the two second coils are electrically connected to the embedded components respectively; and two second magnets are disposed on the lens mount at positions corresponding to the two second coils respectively.

5. The lens driving device as claimed in claim 4, wherein the two second coils are respectively disposed at two adjacent corners of the AF frame and are disposed on a side of the AF frame facing away from a first substrate.

6. The lens driving device as claimed in claim 5, wherein the two second coils are arranged obliquely.

7. The lens driving device as claimed in claim 4, wherein the AF frame defines a first rolling groove and two second rolling grooves, the first rolling groove is disposed between the two second coils, and the two second rolling grooves are positioned opposite to the two second coils respectively; and
wherein a first rolling element is movably disposed in the first rolling groove, second rolling elements are movably disposed in the two second rolling grooves respectively, and the first rolling element and the second rolling elements are movably connected to the lens mount.

8. The lens driving device as claimed in claim 7, wherein each of the second rolling elements is a roller.

9. The lens driving device as claimed in claim 1, wherein the lens driving device further comprises a damping cover plate, and the damping cover plate is connected to the AF frame; and
wherein the lens mount defines a plurality of damping grooves, the damping cover plate is provided with a plurality of damping portions, the plurality of damping portions respectively extend into the plurality of damping grooves, and the plurality of damping portions are movably connected to the plurality of damping grooves respectively.

10. A camera assembly, employing the lens driving device as claimed in claim 1.
